(19) United States
(12) Patent Application Publication
(10) Pub. No.: US 2023/0138313 A1
(43) Pub. Date: May 4, 2023

(54) BLENDS OF ETHYLENE VINYL ACETATE COPOLYMER AND AN ACRYLATE-CONTAINING COPOLYMER AS POUR POINT DEPRESSANTS

(71) Applicant: ECOLAB USA Inc., St. Paul, MN (US)

(72) Inventors: Alexander Coleman PEARSON, Missouri City, TX (US); Regan Andrew JONES, Sugar Land, TX (US)

(73) Assignee: ECOLAB USA Inc., St. Paul, MN (US)

(21) Appl. No.: 17/974,260

(22) Filed: Oct. 26, 2022

Related U.S. Application Data
(60) Provisional application No. 63/273,335, filed on Oct. 29, 2021.

(51) Int. Cl. C08L 91/00

(52) U.S. Cl. CPC C08L 91/00

(57) ABSTRACT

A composition is provided that includes about 1 weight % to about 49 weight % of a copolymer including ethylene and vinyl acetate; about 1 weight % to about 49 weight % of an acrylate-containing copolymer; and about 2 weight % to about 98 weight % of a solvent. The composition can be used to decrease the pour point of a hydrocarbon, such as crude oil.

### TECHNICAL FIELD

The present disclosure generally relates pour point depressants for hydrocarbons. More particularly, the disclosure relates to a composition comprising an ethylene vinyl acetate copolymer and an acrylate-containing copolymer.

### BACKGROUND

Pour point depressants may be used to facilitate the flow of crude oil and other hydrocarbons. For example, hydrocarbon-based feedstocks may contain wax-like structures. The presence of these wax-like structures can result in solidifying or precipitating when the temperature drops, such as below about 0° C., although it can also happen at higher temperatures, such as about 40° C. As additional wax precipitates, the crystals grow and, finally, if the temperature is decreased far enough, the crystals will grow together to form a three-dimensional network that immobilizes the fuel or oil. This solidification process is sometimes referred to as gelation. The precipitation of the wax can also cause problems during the recovery, transport, storage or use of the synthetic feedstocks. The precipitated wax-like materials can block filters, pumps, pipelines, and other installations or be deposited in tanks, thus entailing additional cleaning.

Hence, additives that can depress or lower the pour points to maintain the fluidity of the synthetic feedstocks (e.g., fuel or oil) at lower temperatures are also desirable.

### BRIEF SUMMARY

The present disclosure provides compositions and methods for lowering the pour point of a hydrocarbon. In some embodiments, a composition comprises about 1 wt. % to about 49 wt. % of a copolymer comprising ethylene and vinyl acetate; about 1 wt. % to about 49 wt. % of an acrylate-containing copolymer; and about 2 wt. % to about 98 wt. % of a solvent. The acrylate-containing copolymer comprises the following structure:

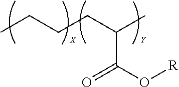

wherein X is an integer from about 1 to about 50, Y is an integer from about 1 to about 15, and R is selected from H or a C₁ to C₅₀ alkyl group. In some embodiments, the acrylate-containing copolymer comprises ethylene and methyl acrylate (EMA).

In certain embodiments, the copolymer comprising the ethylene and the vinyl acetate comprises a weight average molecular weight of about 20,000 to about 100,000 g/mol. In certain embodiments, the acrylate-containing copolymer comprises a weight average molecular weight of about 5,000 g/mol to about 500,000 g/mol.

In some embodiments, the composition comprises about 1 wt. % to about 8 wt. % of the copolymer comprising ethylene and vinyl acetate.

In some embodiments, the composition comprises a ratio of about 0.1:2 to about 2:0.1 of the copolymer comprising ethylene and vinyl acetate to the acrylate-containing copolymer.

In certain embodiments, the composition comprises about 1 wt. % to about 8 wt. % of the acrylate-containing copolymer.

In some embodiments, the composition comprises about 85 wt. % to about 95 wt. % of the solvent. In certain embodiments, the solvent is selected from the group consisting of toluene, naphtha, kerosene, heavy aromatic naphtha, a de-aromatized aliphatic hydrocarbon, an alcohol, and any combination thereof. In certain embodiments, the solvent comprises heavy aromatic naphtha.

The present disclosure also provides a composition comprising a hydrocarbon; a copolymer comprising ethylene and vinyl acetate; an acrylate-containing copolymer; and a solvent. The acrylate-containing copolymer comprises the following structure:

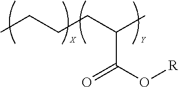

wherein X is an integer from about 1 to about 50, Y is an integer from about 1 to about 15, and R is selected from H or a C₁ to C₅₀ alkyl group.

In some embodiments, the acrylate-containing copolymer comprises ethylene and methyl acrylate.

In some embodiments, the hydrocarbon is selected from the group consisting of topped crude oil, vacuum gas oil, a heavy distillate refiner product, slop oil, a fuel oil, diesel, gasoline, jet fuel, kerosene, and any combination thereof.

In certain embodiments, the copolymer comprising ethylene and vinyl acetate; the acrylate-containing copolymer; and the solvent comprise about 0.001 wt. % to about 5 wt. % of the composition.

In some embodiments, the hydrocarbon has an API gravity of about 15 to about 70.

The present disclosure further provides methods for decreasing the pour point of a hydrocarbon. The methods may comprise adding a composition disclosed herein to the hydrocarbon. The pour point of the hydrocarbon may decrease by, for example, about 10° F. to about 50° F.

Also disclosed is the use of a composition provided herein for decreasing the pour point of a hydrocarbon.

The foregoing has outlined rather broadly the features and technical advantages of the present disclosure in order that the detailed description that follows may be better understood. Additional features and advantages of the disclosure will be described hereinafter that form the subject of the claims of this application. It should be appreciated by those skilled in the art that the conception and the specific embodiments disclosed may be readily utilized as a basis for modifying or designing other embodiments for carrying out the same purposes of the present disclosure. It should also be realized by those skilled in the art that such equivalent embodiments do not depart from the spirit and scope of the disclosure as set forth in the appended claims.

### DETAILED DESCRIPTION

The terms “polymer,” “copolymer,” “polymerize,” “copolymerize,” and the like include not only polymers comprising two monomer residues and polymerization of two monomers together, but also include (co)polymers comprising more than two monomer residues and polymerizing more than two monomers together. For example, a polymer as disclosed herein includes a terpolymer, a tetrapolymer, polymers comprising more than four different monomers, as well as polymers comprising, consisting of, or consisting essentially of two different monomer residues. Additionally, a “polymer” as disclosed herein may also include a homopolymer, which is a polymer comprising a single type of monomer unit.

Unless specified differently, the polymers of the present disclosure may be linear, branched, crosslinked, structured, synthetic, semi-synthetic, natural, and/or functionally modified. A polymer of the present disclosure can be in the form of a solution, a dry powder, a liquid, or a dispersion, for example.

The term “pour point” is the lowest temperature at which a liquid will pour or flow under a specific set of conditions. Examples of pour point standards include ASTM D97-11, D5853-11, and D5949-10.

The term “pour point depressants” are molecules that reduce or inhibit wax crystal formation in feedstocks, such as feedstocks derived from plastic, resulting in lower pour point and improved low or cold temperature flow performance.

The term “synthetic feedstock” refers to hydrocarbons obtained from treatment or processes on plastics.

Disclosed herein are compositions and methods that improve the cold flow properties of hydrocarbons, such as synthetic feedstocks, for plastics. The cold flow properties can be improved by additives that prevent the formation of wax-like structures and lower the temperature at which the synthetic feedstock solidifies. This helps to ensure uninterrupted flow of the synthetic feedstock. Such additives are referred to as pour point depressants or flow improvers.

A composition is provided herein that includes about 1 wt. % to about 49 wt. % of a copolymer comprising ethylene and vinyl acetate (EVA); about 1 wt. % to about 49 wt. % of an acrylate-containing copolymer; and about 2 wt. % to about 98 wt. % of a solvent.

The acrylate-containing copolymer comprises the following structure:

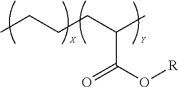

wherein X is an integer from about 1 to about 50, Y is an integer from about 1 to about 15, and R is selected from H or a C₁ to C₅₀ alkyl group.

In some embodiments, X in an integer from about 1 to about 40, from about 1 to about 30, from about 1 to about 20, from about 1 to about 10, from about 1 to about 5, from about 3 to about 5, from about 3 to about 15, from about 3 to about 25, or from about 3 to about 30.

In some embodiments, Y is an integer from about 1 to about 12, from about 1 to about 10, from about 1 to about 8, from about 1 to about 6, from about 1 to about 4, or from about 1 to about 2.

In some embodiments, R is selected from a C₁ to C₄₀ alkyl group, a C₁ to C₃₀ alkyl group, a C₁ to C₂₀ alkyl group, a C₁ to C₁₀ alkyl group or a C₁ to C₅ alkyl group. For example, R may be a C₁, C₂, C₃, C₄ or a C₅ alkyl group. The alkyl group may be linear, branched, substituted, and/or unsubstituted.

Copolymers comprising ethylene and vinyl acetate can be prepared by copolymerizing ethylene with vinyl acetate. Other monomers can be copolymerized with ethylene and vinyl acetate. In some aspects, the copolymer comprising ethylene and vinyl acetate consists of the monomers ethylene and vinyl acetate.

In some aspects, the vinyl acetate in the ethylene vinyl acetate copolymer is from about 1 to about 60 wt. % of the total copolymer; or from about 10 to about 25 wt. %; from about 10 to about 20 wt. %; from about 10 to about 50 wt. %; from about 25 to about 40 wt. %; from about 25 to about 50 wt. %; from about 15 to about 25 wt. %; from about 25 wt. % to about 35 wt. %; or from about 30 wt. % to about 35 wt. %.

In some aspects, the copolymer of ethylene and vinyl acetate has a weight average molecular weight from about 20,000 to about 100,000 g/mol; from about 25,000 to about 85,000 g/mol; or from about 45,000 to about 55,000 g/mol. In some aspects, the weight average molecular weight of the copolymer comprising ethylene and vinyl acetate can be about 25,000 g/mol; about 28,000 g/mol; about 45,000 g/mol; about 48,000 g/mol; about 56,000 g/mol; about 58,000 g/mol; about 65,000 g/mol; or about 83,000 g/mol. In some embodiments, the molecular weight can be determined by gel permeation chromatography (GPC).

In some aspects, the composition comprises about 1 wt. % to about 35 wt. % of the copolymer of ethylene and vinyl acetate. For example, the composition may comprise about 1 wt. % to about 30 wt. %, about 1 wt. % to about 25 wt. %, about 1 wt. % to about 20 wt. %, about 1 wt. % to about 15 wt. %, about 1 wt. % to about 10 wt. %, or about 1 wt. % to about 5 wt. % of the copolymer of ethylene and vinyl acetate. In some aspects, the composition comprises about 1 wt. %, about 2 wt. %, about 3 wt. %, about 4 wt. %, about 5 wt. %, about 6 wt. %, about 7 wt. % or about 8 wt. % of the copolymer of ethylene and vinyl acetate.

In some embodiments, the acrylate-containing polymer comprises an ethylene and methyl acrylate copolymer, which can be prepared by copolymerizing ethylene with methyl acrylate. Other monomers can be copolymerized with the ethylene and methyl acrylate. In some aspects, the ethylene and methyl acrylate copolymer consists of the monomers of ethylene and methyl acrylate.

In some aspects, the acrylate-containing copolymer has a weight average molecular weight of from about 5,000 g/mol to about 500,000 g/mol. For example, the acrylate-containing copolymer may have a weight average molecular weight from about 50,000 to about 400,000, from about 100,000 to about 300,000 or from about 150,000 to about 250,000 g/mol. In some aspects, the weight average molecular weight can be determined by GPC.

In some aspects, the acrylate-containing copolymer has a melt flow index from about 1 to about 1,000 g/10 mn as determined by ASTM D1238. For example, the melt flow index may be from about 1 to about 500, from about 1 to about 100, from about 1 to about 50, from about 1 to about 25, from about 1 to about 15, from about 1 to about 10 or from about 1 to about 5 g/10 mn. In some embodiments, the melt flow index is 1, 2, 3, 4 or 5 g/10 mn.

In some aspects, the composition comprises about 1 wt. % to about 35 wt. % of the acrylate-containing copolymer. For example, the composition may comprise about 1 wt. % to about 30 wt. %, about 1 wt. % to about 25 wt. %, about 1 wt. % to about 20 wt. %, about 1 wt. % to about 15 wt. %, about 1 wt. % to about 10 wt. %, or about 1 wt. % to about 5 wt. % of the acrylate-containing copolymer. In some aspects, the composition comprises about 1 wt. %, about 2 wt. %, about 3 wt. %, about 4 wt. %, about 5 wt. %, about 6 wt. %, about 7 wt. % or about 8 wt. % of the acrylate-containing copolymer.

In some embodiments, the composition comprises a greater weight percentage of the acrylate-containing copolymer than the copolymer of ethylene and vinyl acetate. For example, if the composition comprises 10 wt. % of the acrylate-containing copolymer, then the composition includes less than 10 wt. % of the copolymer comprising ethylene and vinyl acetate.

In other embodiments, the composition comprises a greater weight percentage of the copolymer of ethylene and vinyl acetate than the acrylate-containing copolymer. For example, if the composition comprises 10 wt. % of the copolymer comprising ethylene and vinyl acetate, then the composition includes less than 10 wt. % of the acrylate-containing copolymer.

In some embodiments, the composition comprises a ratio of acrylate-containing copolymer to copolymer of ethylene and vinyl acetate of about 2:1 to about 1:2. For example, the ratio may be about 1.5:1, about 1:1, or about 1:1.5.

The composition also includes a solvent. Examples of solvents include, but are not limited to, toluene, naphtha, kerosene, heavy aromatic naphtha, an alcohol, and any combination thereof. In some aspects, the solvent is naphtha, heavy aromatic naphtha, or any combination thereof. In some aspects, the solvent is naphtha. In some aspects, the solvent is heavy aromatic naphtha.

In some aspects, the composition comprises about 2 wt. % to about 98 wt. % of the solvent. In some aspects, the composition comprises about 50 wt. % to about 98 wt. %, about 60 wt. % to about 98 wt. %, about 65 wt. % to about 98 wt. %, about 70 wt. % to about 98 wt. %, about 75 wt. % to about 98 wt. %, about 80 wt. % to about 98 wt. %, about 85 wt. % to about 98 wt. %, or about 90 wt. % to about 98 wt. % of the solvent.

In an embodiment, the composition comprises, consists of, or consists essentially of about 5 wt. % of the acrylate-containing copolymer, about 5 wt. % of the copolymer of ethylene and vinyl acetate, and about 90 wt. % of a solvent, such as heavy aromatic naphtha.

Preparation of pour point depressant polymers may be made by any method known in the art, such as by solution polymerization of free radical initiation or high pressure polymerizations that may be carried out in an autoclave or suitable reactor.

In some embodiments, the pour point depressant can include one or more additional components, such as other pour point dispersants, paraffin inhibitors, asphaltene dispersants, wax dispersants, tar dispersants, neutralizers (e.g. amine neutralizers), surfactants, biocides, preservatives, stabilizers, or any combination thereof.

Wax dispersants can stabilize paraffin crystals that have formed and prevent them from sedimenting. The wax dispersants used may be, for example, alkylphenols, alkylphenol-formaldehyde resins or dodecylbenzenesulfonic acid.

In another aspect, a composition comprising a hydrocarbon is provided. The composition further comprises a copolymer of ethylene and vinyl acetate; an acrylate-containing copolymer, such as an ethylene and methyl acrylate copolymer; and a solvent.

The hydrocarbon is selected from the group consisting of topped crude oil, vacuum gas oil, a heavy distillate refiner product, slop oil, a fuel oil, diesel, gasoline, jet fuel, kerosene, and any combination thereof. In some aspects, the hydrocarbon is petroleum-based having an API gravity of about 15-70. In some aspects, the hydrocarbon is not diesel, gasoline, or kerosene. Crude oil is generally known to be a naturally occurring hydrocarbon mixture, usually in a liquid state, which may include additional components, such as sulfur, nitrogen, oxygen, metals, and other elements.

In some aspects, the hydrocarbon comprises a synthetic feedstock resulting from a pyrolysis reaction. In some aspects, the hydrocarbon comprises pyrolysis effluent.

The pyrolysis reaction produces a range of hydrocarbon products from gases (at temperatures from about 10 to about 50° C. and about 0.5 to about 1.5 atmospheric pressure and having 5 carbons or less); modest boiling point liquids (like gasoline (about 40 to about 200° C.) or diesel fuel (about 180 to about 360° C.); a higher (e.g., at about 250 to about 475° C.) boiling point liquid (oils and waxes), and some solid residues, commonly referred to as char. Char is the material that is left once the pyrolytic process is complete and the fuel recovered. Char contains the additives and contaminants that enter the system as part of the feedstock. The char can be a powdery residue or substance that is more like sludge with a heavy oil component. Glass, metal, calcium carbonate/oxide, clay and carbon black are just a few of the contaminants and additives that will remain after the conversion process is complete and become part of the char.

Various plastic types, such as thermoplastic and thermoset waste plastics, and recycled plastic oils, can be used in the above-described process. The types of plastics commonly encountered in waste-plastic feedstock include, without limitation, low-density polyethylene, high-density polyethylene, polypropylene, polystyrene, the like, and combinations thereof.

In some embodiments, the pyrolysis of plastic results in synthetic feedstocks that include 2-30% gas (C₁-C₄ hydrocarbon); (2) 10-50% oil (C₅-C₁₅ hydrocarbon); (3) 10-40% waxes (≥C₁₆ hydrocarbon); and (4) 1-5% char and tar.

The hydrocarbons that derive from the pyrolysis of waste plastic are a mixture of alkanes, alkenes, olefins and diolefins. The olefin group is generally between C₁ and C₂, i.e., alpha-olefin, but some alk-2-ene is also produced. The diene is generally in the alpha and omega position, i.e., alk-α,ω-diene. In some embodiments, the pyrolysis of plastic produces paraffin compounds, isoparaffins, olefins, diolefins, naphthenes and aromatics.

In some aspects, the percentage of 1-olefins in the pyrolysis effluent is from about 25 to about 75 wt. % or from about 40 to about 60 wt. %. Pyrolysis conditions include a temperature from about 500 to about 700° C. or from about 600 to about 700° C.

Depending on the processing conditions, synthetic feedstock can have characteristics similar to crude oil from petroleum sources but can also have ash and wax of different ranges. In some aspects, the synthetic feedstock derived from waste plastic contains waxy hydrocarbons from C₁₆-C₃₆; C₁₆-C₂₀; C₂₁-C₂₉; or C₃₀-C₃₆. In other aspects, the synthetic feedstock derived from waste plastic contains waxy hydrocarbons with the C₁₆-C₂₀ fraction representing about 50-60 wt. % of the wax molecules, the C₂₁-C₂₉ fraction being about 40-50 wt. % of the wax molecules and C₃₀+ fraction being less than about 2 wt. % of the wax fraction; the waxy fraction is about 10-20 wt. % of the recovered synthetic feedstock fraction.

In still other aspects, the synthetic feedstocks have about 15-20 wt. % C₉-C₁₆; about 75-87 wt. % C₁₆-C₂₉; and about 2-5 wt. % C₃₀+, where the carbon chains are predominantly a mixture of alkanes, alkenes and diolefins. In other aspects, the synthetic feedstocks have about 10 wt. % <C₁₂, about 25 wt. % C₁₂-C₂₀, about 30 wt. % C₂₁-C₄₀ and about 35 wt. % >C₄₁.

Unlike the synthetic feedstock derived from plastics, conventional crude oil that suffers from pour point issues has a broad range of hydrocarbon species where the non-waxy components may help offset some of the waxy nature of these troublesome crude oils. In a conventional waxy crude oil, the waxy components range from C₁₆ to C₈₀+. In one example of a crude, the waxy molecules with a carbon chain range of C₂₂-C₄₀, display a roughly Gaussian distribution and the majority of the waxy molecules were in the C₂₈-C₃₆ range. In another example of a crude, the waxy carbon chain length ranged from C₁₅ to C₁₁₀, the distribution can be bimodal with the majority of the waxy molecules being in the C₂₄ to C₂₈ or C₃₆ to C₅₂ range.

While there are known dewaxing methods for reducing waxy feeds, either by solvent removal or catalytic dewaxing or isomerization, most of these processes are expensive. In some embodiments, the compositions disclosed herein are pour point depressants that lower pour points of synthetic feedstocks derived from plastics (e.g., waste plastic).

In some aspects, the synthetic feedstock composition has waxy constituents that can precipitate from the synthetic feedstock composition at a temperature greater than its desired or intended storage, transport, or use temperature. In some aspects, the synthetic feedstock composition can have a wax content greater than about 1 wt. %; greater than about 5 wt. %; or greater than about 10 wt. %. In some aspects, the wax content in the synthetic feedstocks is about 5-40 wt. %; about 5-30 wt. %; about 10-25 wt. %; about 15-20 wt. %; about 10-20 wt. %; or about 10-30 wt. %.

In the embodiments where the composition includes a hydrocarbon, the copolymer of ethylene and vinyl acetate; the acrylate-containing copolymer; and the solvent comprise, in total, about 0.001 wt. % to about 5 wt. % of the composition. For example, the copolymer of ethylene and vinyl acetate; the acrylate-containing copolymer; and the solvent may comprise, in total, from about 0.001 wt. % to about 3 wt. %, from about 0.001 wt. % to about 1 wt. %, from about 0.001 wt. % to about 0.5 wt. %, from about 0.001 wt. % to about 0.1 wt. % or from about 0.001 wt. % to about 0.01 wt. % of the composition.

In another aspect, a method of decreasing the pour point of a hydrocarbon is provided. The method includes adding to the hydrocarbon a composition comprising about 1 wt. % to about 49 wt. % of a copolymer comprising ethylene and vinyl acetate; about 1 wt. % to about 49 wt. % of an acrylate-containing copolymer; and about 2 wt. % to about 98 wt. % of a solvent.

The acrylate-containing copolymer comprises the following structure:

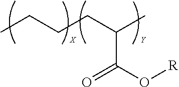

wherein X is an integer from about 1 to about 50, Y is an integer from about 1 to about 15, and R is selected from H or a C₁ to C₅₀ alkyl group.

In some aspects, the pour point of the hydrocarbon decreases by about 10° F. to about 50° F. In some aspects, the pour point of the hydrocarbon decreases by about 10° F., about 15° F., about 20° F., about 25° F., about 30° F., about 35° F., about 40° F., about 45° F., or about 50° F.

The method of applying the pour point depressant to the hydrocarbon, such as a synthetic feedstock, is not particularly limited. One of skill will appreciate that the synthetic feedstock additives, such as the pour point depressant, are conventionally added by using available equipment including e.g., pipes, mixers, pumps, tanks, injection ports, and the like.

In some aspects, the pour point depressant is added into a synthetic feedstock obtained from plastics. In other aspects, the pour point depressant is added to a synthetic feedstock that contains waxes. In still other aspects, any composition disclosed herein is added to a synthetic feedstock that contains waxes, char and tar. In some aspects, any composition disclosed herein is added to a synthetic feedstock that contains waxes having C₁₆-C₃₆, char and tar.

In some aspects, any composition disclosed herein is a suitable pour point depressant for synthetic feedstock having about 15-20 wt. % C₉-C₁₆; about 75-87 wt. % C₁₆-C₂₉; about 2-5 wt. % C₃₀+, where the carbon chains are predominantly a mixture of alkanes, alkenes and diolefins. In still other aspects, any composition disclosed herein is a suitable pour point depressant for synthetic feedstock having about 10 wt. % <C₁₂, about 25 wt. % C₁₂-C₂₀, about 30 wt. % C₂₁-C₄₀ and about 35 wt. % >C₄₁.

The effective amount of the composition used depends on the type of synthetic feedstock obtained from the plastic type processed, the temperature and other characteristics of the process. In some aspects, the composition is added in an amount from about 50 ppm to about 10,000 ppm; about 50 ppm to about 5,000 ppm; about 550 ppm to about 5,000 ppm; about 250 ppm to about 1000 ppm; about 50 ppm to about 1,000 ppm; about 150 to about 450 ppm; or about 50 ppm to about 500 ppm in the synthetic feedstock.

Flow properties of the synthetic feedstock can be evaluated by any known method or test. For example, pour points can be measured according to ASTM D97.

In some aspects, the synthetic feedstocks with the composition have pour points (measured under ASTM D97) of less than about −24° C., less than about −20° C.; less than about −10° C., or less than about −5° C. Such synthetic feedstocks continue to flow, thereby being allowed to be poured, pumped or transferred at temperatures between, for example, about −40 to about 20° C. In some aspects, the hydrocarbons containing the compositions flow, and thus are pourable or pumpable, at temperatures as low as about −40° C., or about 20 to about −40° C.; about −5 to about −40° C., about −10 to about −40° C., about −15 to about −40° C., about −20 to about −40° C., about −25 to about −40° C., or about −30 to about −40° C.

### EXAMPLES

Various compositions were added to different crude oils. All tests were performed using ASTM D97 and ASTM D5950. The compositions of the polymers are provided in Table 1 and their formulations are described below.

TABLE 1
Polymer compositions

| | | wt % Methyl | wt % Vinyl | |
|---|---|---|---|---|
| Polymer | Type | Acrylate | Acetate | Melt Index |
| 1 | EMA | 30 | — | 3 |
| 2 | EVA | — | 33 | 45 |

Formulation 1: EMA Polymer 1 (about 5 wt. %) and EVA polymer 2 (about 5 wt. %) in heavy aromatic naphtha (about 90 wt. %).

Formulation 2: EVA polymer 2 (about 20 wt. %) and heavy aromatic naphtha (about 80 wt. %).

Formulation 3: A solution of EMA polymer 1 (about 20 wt. %) and heavy aromatic naphtha (about 80 wt. %).

EVA copolymers are highly effective pour point depressants but can decompose to acetic acid at high temperatures in refinery environments, leading to a corrosion risk. EMA copolymers are known to have improved high temperature stability in comparison to EVA. However, EMA polymer 1 has reduced pour point depression performance compared to EVA polymer 2. Surprisingly, mixtures of EVA and EMA copolymers show similar or superior performance to the EVA or EMA alone, on a % actives basis. These mixtures are desirable for their excellent pour point depressant properties and reduced corrosion risk due to lower total EVA content. The results shown in the following Tables support the conclusion that the present inventors have discovered unexpected synergy.

TABLE 2
Pour Point Results for Crude Oil 1

| | | | Pour Point |
|---|---|---|---|
| Additive(s) | PPM Active EVA | PPM Active EMA | (° F.) |
| Blank | — | — | 65 |
| Formulation 2 | 50 | — | 50 |
| Formulation 2 | 100 | — | 40 |
| Formulation 2 | 200 | — | 30 |
| Formulation 3 | — | 50 | 60 |
| Formulation 3 | — | 100 | 50 |
| Formulation 3 | — | 200 | 35 |
| Formulation 1 | 12.5 | 12.5 | 60 |
| Formulation 1 | 50 | 50 | 35 |

TABLE 3
Pour Point Results for Crude Oil 2

| | | | Pour Point |
|---|---|---|---|
| Additive(s) | PPM Active EVA | PPM Active EMA | (° F.) |
| Blank | — | — | 55 |
| Formulation 2 | 50 | — | 55 |
| Formulation 2 | 100 | — | 45 |
| Formulation 2 | 200 | — | 40 |
| Formulation 2 | 300 | — | 40 |
| Formulation 3 | — | 50 | 55 |
| Formulation 3 | — | 100 | 50 |
| Formulation 3 | — | 200 | 45 |
| Formulation 3 | — | 300 | 40 |
| Formulation 1 | 12.5 | 12.5 | 50 |
| Formulation 1 | 25 | 25 | 55 |
| Formulation 1 | 50 | 50 | 40 |
| Formulation 1 | 75 | 75 | 35 |

TABLE 4
Pour Point Results for Crude Oil 3

| | | | Pour Point |
|---|---|---|---|
| Additive | PPM Active EVA | PPM Active EMA | (° F.) |
| Blank | — | — | 50 |
| Formulation 2 | 12.5 | — | 45 |
| Formulation 2 | 50 | — | 40 |
| Formulation 2 | 100 | — | 35 |
| Formulation 2 | 200 | — | 25 |
| Formulation 3 | — | 12.5 | 45 |
| Formulation 3 | — | 50.0 | 45 |
| Formulation 3 | — | 100 | 40 |
| Formulation 3 | — | 200 | 35 |
| Formulation 1 | 12.5 | 12.5 | 45 |
| Formulation 1 | 25 | 25 | 40 |
| Formulation 1 | 50 | 50 | 35 |

As an illustrative example of the discovered synergy, Table 2 shows that at about 50 ppm active EVA, the pour point was about 50° F. At about 50 ppm EMA, the pour point was about 60° F. However, in Formulation 1, which includes about 50 ppm EVA and about 50 ppm EMA, the pour point was reduced to about 35° F.

Various ethylene vinyl acetate polymers were tested having different weight average molecular weights to determine the effect of molecular weight on pour point depression. Table 5 shows the molecular weights, weight % vinyl acetate, and melt indices of different ethylene vinyl acetate polymers. Table 6 shows the effect of various compositions on the pour point.

TABLE 5
Composition of EVA Copolymers

| | Weight Average | | |
|---|---|---|---|
| EVA | Molecular Weight | wt % Vinyl Acetate | Melt Index |
| EVA 1 | 25,000 | 28 | 800 |
| EVA 2 | 27,421 | 28 | 420 |
| EVA 3 | 45,500 | 42 | 60 |
| EVA 4 | 48,000 | 33 | 45 |
| EVA 5 | 65,158 | 28 | 3 |
| EVA 6 | 83,094 | 24 | 3 |

TABLE 6
Pour Point Performance of various EVA/EMA blends

| | ppm | ppm | Pour Point |
|---|---|---|---|
| Sample | EMA | EVA | (° F.) |
| Untreated Oil | 0 | 0 | 60 |
| Formulation 3 | 25 | 0 | 60 |
| Formulation 3 | 100 | 0 | 55 |
| Formulation 3 | 400 | 0 | 40 |
| 25% Formulation 3:5% EVA 5 | 25 | 25 | 45 |
| 25% Formulation 3:5% EVA 5 | 100 | 100 | 35 |
| 20% EVA 5 | 0 | 25 | 55 |
| 20% EVA 5 | 0 | 100 | 40 |
| 25% Formulation 3:5% EVA 2 | 25 | 25 | 50 |
| 25% Formulation 3:5% EVA 2 | 100 | 100 | 35 |
| 20% EVA 2 | 0 | 25 | 50 |
| 20% EVA 2 | 0 | 100 | 45 |
| 25% Formulation 3:5% EVA 1 | 25 | 25 | 50 |
| 25% Formulation 3:5% EVA 1 | 100 | 100 | 35 |
| 20% EVA 1 | 0 | 25 | 50 |
| 20% EVA 1 | 0 | 100 | 45 |
| 25% Formulation 3:5% EVA 6 | 25 | 25 | 45 |
| 25% Formulation 3:5% EVA 6 | 100 | 100 | 30 |
| 20% EVA 6 | 0 | 25 | 50 |
| 20% EVA 6 | 0 | 100 | 40 |
| 25% Formulation 3:5% EVA 3 | 25 | 25 | 50 |
| 25% Formulation 3:5% EVA 3 | 100 | 100 | 45 |
| 20% EVA 3 | 0 | 25 | 50 |
| 20% EVA 3 | 0 | 100 | 45 |
| 25% Formulation 3:5% EVA 4 | 25 | 25 | 45 |
| 25% Formulation 3:5% EVA 4 | 100 | 100 | 35 |
| 20% EVA 4 | 0 | 25 | 50 |
| 20% EVA 4 | 0 | 100 | 40 |

As an illustrative example of the discovered synergy, Table 6 shows that at about 25 ppm active EMA (Formulation 3), the pour point was about 60° F. (same as untreated). At about 25 ppm EVA (20% EVA 5), the pour point was about 55° F. However, in the mixture “25% Formulation 3: 5% EVA 5,” which includes about 25 ppm EMA and about 25 ppm EVA, the pour point was about 45° F.

All of the compositions and methods disclosed and claimed herein can be made and executed without undue experimentation in light of the present disclosure. While this invention may be embodied in many different forms, there are described in detail herein specific preferred embodiments of the invention. The present disclosure is an exemplification of the principles of the invention and is not intended to limit the invention to the particular embodiments illustrated. In addition, unless expressly stated to the contrary, use of the term “a” is intended to include “at least one” or “one or more.” For example, “a polymer” is intended to include “at least one polymer” or “one or more polymers.”

Any ranges given either in absolute terms or in approximate terms are intended to encompass both, and any definitions used herein are intended to be clarifying and not limiting. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges (including all fractional and whole values) subsumed therein.

Any composition disclosed herein may comprise, consist of, or consist essentially of any element, component and/or ingredient disclosed herein or any combination of two or more of the elements, components or ingredients disclosed herein.

Any method disclosed herein may comprise, consist of, or consist essentially of any method step disclosed herein or any combination of two or more of the method steps disclosed herein.

The transitional phrase “comprising,” which is synonymous with “including,” “containing,” or “characterized by,” is inclusive or open-ended and does not exclude additional, un-recited elements, components, ingredients and/or method steps.

The transitional phrase “consisting of” excludes any element, component, ingredient, and/or method step not specified in the claim.

The transitional phrase “consisting essentially of” limits the scope of a claim to the specified elements, components, ingredients and/or steps, as well as those that do not materially affect the basic and novel characteristic(s) of the claimed invention.

Unless specified otherwise, all molecular weights referred to herein are weight average molecular weights and all viscosities were measured at 25° C. with neat (not diluted) polymers.

As used herein, the term “about” refers to the cited value being within the errors arising from the standard deviation found in their respective testing measurements, and if those errors cannot be determined, then “about” may refer to, for example, within 5% of the cited value.

Furthermore, the invention encompasses any and all possible combinations of some or all of the various embodiments described herein. It should also be understood that various changes and modifications to the presently preferred embodiments described herein will be apparent to those skilled in the art. Such changes and modifications can be made without departing from the spirit and scope of the invention and without diminishing its intended advantages. It is therefore intended that such changes and modifications be covered by the appended claims.

What is claimed is:

1. A composition, comprising:
about 1 wt. % to about 49 wt. % of a copolymer comprising ethylene and vinyl acetate;
about 1 wt. % to about 49 wt. % of an acrylate-containing copolymer; and
about 2 wt. % to about 98 wt. % of a solvent,
wherein the acrylate-containing copolymer comprises the following structure: 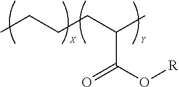
wherein X is an integer from about 1 to about 50, Y is an integer from about 1 to about 15, and R is selected from H or a C₁ to C₅₀ alkyl group.

2. The composition of claim 1, wherein the acrylate-containing copolymer comprises ethylene and methyl acrylate.

3. The composition of claim 1, wherein the copolymer comprising the ethylene and the vinyl acetate comprises a weight average molecular weight of about 20,000 to about 100,000 g/mol.

4. The composition of claim 1, wherein the acrylate-containing copolymer comprises a weight average molecular weight of about 5,000 g/mol to about 500,000 g/mol.

5. The composition of claim 1, wherein the composition comprises about 1 wt. % to about 8 wt. % of the copolymer comprising ethylene and vinyl acetate.

6. The composition of claim 1, wherein the composition comprises a ratio of about 0.1:2 to about 2:0.1 of the copolymer comprising ethylene and vinyl acetate to the acrylate-containing copolymer.

7. The composition of claim 1, wherein the composition comprises about 1 wt. % to about 8 wt. % of the acrylate-containing copolymer.

8. The composition of claim 1, wherein the composition comprises about 85 wt. % to about 95 wt. % of the solvent.

9. The composition of claim 1, wherein the solvent is selected from the group consisting of toluene, naphtha, kerosene, heavy aromatic naphtha, a de-aromatized aliphatic hydrocarbon, an alcohol, and any combination thereof.

10. The composition of claim 1, wherein the solvent comprises heavy aromatic naphtha.

11. A composition, comprising:
a hydrocarbon;
a copolymer comprising ethylene and vinyl acetate;
an acrylate-containing copolymer; and
a solvent,
wherein the acrylate-containing copolymer comprises the following structure: 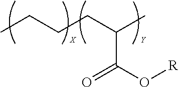
wherein X is an integer from about 1 to about 50, Y is an integer from about 1 to about 15, and R is selected from H or a C₁ to C₅₀ alkyl group.

12. The composition of claim 11, wherein the hydrocarbon is selected from the group consisting of topped crude oil, vacuum gas oil, a heavy distillate refiner product, slop oil, a fuel oil, diesel, gasoline, jet fuel, kerosene, and any combination thereof.

13. The composition of claim 11, wherein the copolymer comprising ethylene and vinyl acetate; the acrylate-containing copolymer; and the solvent comprise about 0.001 wt. % to about 5 wt. % of the composition.

14. The composition of claim 11, wherein the hydrocarbon has an API gravity of about 15 to about 70.

15. A method of decreasing the pour point of a hydrocarbon, comprising:
adding the composition of claim 1 to the hydrocarbon.

16. The method of claim 15, wherein the pour point of the hydrocarbon decreases by about 10° F. to about 50° F.
